(19) United States
(12) Patent Application Publication
(10) Pub. No.: US 2021/0047804 A1
(43) Pub. Date: Feb. 18, 2021

(54) Mixed Reality Method And System For Precision Mining

(71) Applicant: GOLDCORP Inc., Greenwood Village, CO (US)

(72) Inventor: Luis Canepari, Vancouver (CA)

(21) Appl. No.: 17/049,411

(22) PCT Filed: Mar. 1, 2019
(86) PCT No.: PCT/CA2019/050248

§ 371 Date: Oct. 21, 2020

Related U.S. Application Data
(60) Provisional application No. 62/663,729, filed on Apr. 27, 2018.

(51) Int. Cl. E02F 9/26; E02F 9/20; G05D 1/00; G06T 17/05; G06T 17/20; G06T 19/00

(52) U.S. Cl. CPC E02F 9/262; E02F 9/265; E02F 9/205; G05D 2201/021; G06T 17/05; G06T 17/20; G06T 19/006; G05D 1/0038

(57) ABSTRACT

A precision mining system having mining equipment manipulable to recover material with mineral resources, the system comprising: an image sensor for capturing real-time imagery of a geographical location having material with mineral resources and at least one element of the mining equipment; a storage device comprising instructions and the real-time imagery; and a processor configured to execute the instructions to receive, from the image sensor, real-time imagery; at least one sensing device associated with at least one element of the mining equipment configured to acquire data corresponding to at least one of position and motion of the at least one element of the mining equipment in the real-time imagery; and the processor configured to execute the instructions to generate at least one production polygon corresponding to a volume of interest with the mineral resources and combine the real-time imagery with the at least one production polygon to generate real-time composite imagery.

### FIELD OF THE INVENTION

The present invention relates to mining operations, more particularly it relates to operating mining equipment with improved accuracy based on real-time guidance and feedback from an augmented vision and mixed reality method and system.

### BACKGROUND

Open-pit mining is a surface mining technique of extracting rock or minerals from the earth by excavating the rock or minerals from an open pit. Open pit mines are generally used extensively in mining for ores such as copper, gold, iron, aluminum, and other minerals. This mining method is suitable for locations with a wide area of exposed minerals or minerals that exist close to the surface and continue to a greater depth.

The main objective in any commercial mining operation is the exploitation of the mineral deposit at the lowest possible cost with a view of maximizing profits. A multitude of planning activities are involved in an open-pit mine operation, and these may include day-to-day decision-making on the positioning of equipment, truck dispatch, ore characteristics or quality; long-term and strategic decision-making on the timing of expansions, and the opening or closing of regions of the mine site. Furthermore, the selection of physical design parameters and the scheduling of the ore and waste extraction program are complex engineering decisions of enormous economic significance. Typically, the design is prepared based on the surface topography, geology, 3D configuration of the ore body with respect to its shape, size, inclination, depth, grade distribution, hydrology etc.

One of the most challenging aspects of open-pit mining is distinguishing between rock material that contains a significant amount of minerals or ore for extraction and waste rock which contains minerals in concentrations considered too low to be extracted at a profit. In most situations, production polygons based on the geological attributes of the area of interest with possible mineral deposit are often used as guides for excavation. These polygons are often drawn by hand and are based on the engineer's experience and knowledge of the deposit, or can be modelled using mine production planning modelling techniques and/or software. Typically, a planner selects regions of the open-pit with ore to be excavated, and a production polygon is generated by dividing the ore body into a grid of equally-sized blocks, where each block is assigned an estimate of its grade (metal content in the context of mining metal ores) and other relevant quality attributes. The production polygons are then defined on the open-pit surface by physical markers, such as spray paint, stakes, and multiple screens. Next, the production polygons are provided to mining equipment operators who are tasked to remove the rock material from the open-pit mine and load the excavated rock material in the correct stream, such as an ore stream, an ore/waste stream, or a waste stream, based on the production polygons. Unfortunately the production polygons are often not properly identified due to the imprecise placement of the physical markers, which can lead to mineral ore ending up in the waste stream and/or waste material ending up in the ore stream.

In addition, it is important to realize that the mining equipment used in the mining operations is of extremely large scale. For instance, some mining shovels can weigh as much as 3 million pounds, and can include a 4-meter wide bucket having a loading capacity of 30 m³ of rock material. As one can appreciate, guiding a 4-metre wide bucket or operating such a bucket to excavate the intended rock material within the predefined production polygon can be rather challenging, and often leads to the bucket being positioned or oriented imprecisely when excavating. Furthermore, operating such equipment requires substantial experience and dexterity, and therefore inexperience and human error can only exacerbate the issue.

The productivity rate of equipment operators is typically measured on bucket volume of mineral ore, such as the number of full buckets excavated, which inevitably leads to intentional ore stream or waste stream misclassification of the buckets by the equipment operators, in order to meet the set targets. Therefore, while incentivizing on volume over proper classification leads to increased wages and/or recognition for the equipment operators, the consequences for the mine operator include unrealized earnings, wasted manpower, wasted resources, and inefficient use of equipment, however. For example, even misclassification rates which may be considered to be insignificant can result in considerable change in EBITDA (earnings before interest, taxes, depreciation and amortization) for a mining operator. In one study, it was found that a misclassification rate of 0.5% resulted in annual EBITDA losses of $10.2 million; a misclassification rate of 1.5% resulted in annual EBITDA losses of $20.4 million; a misclassification rate of 2.5% resulted in annual EBITDA losses of $50.9 million; and a misclassification rate of 5.0% resulted in annual EBITDA losses of $101.8 million, assuming certain production volumes, recovery rates, resource prices, production costs and ore densities.

While many approaches have been proposed to address these issues, none of them have been able to improve the accuracy of mining shovels, and other mining equipment, in order to reduce the misclassification rate.

it is thus an object of the present invention to mitigate or obviate at least one of the above-mentioned disadvantages.

### SUMMARY OF THE INVENTION

In one of its aspects, there is provided a precision mining system comprising mining equipment manipulable to recover material with mineral resources, the system comprising:
an image sensor for capturing real-time imagery of a geographical location having material with mineral resources and at least one element of the mining equipment;
a display device;
a storage device comprising instructions and the real-time imagery; and
a processor configured to execute the instructions to receive, from the image sensor, real-time imagery;
at least one sensing device associated with at least one element of the mining equipment configured to acquire data corresponding to at least one of position and motion of the at least one element of the mining equipment in the real-time imagery;
the processor configured to execute the instructions to generate at least one production polygon corresponding to a volume of interest with the mineral resources;
an image processing system adapted to receive the real-time imagery and the at least one production polygon, the image processing system comprising a second set of instructions stored in the storage device and the instructions executable by the processor to cause the processor to combine the real-time imagery with the at least one production polygon to generate real-time composite imagery; and
a display unit for presenting the real-time composite imagery as a guide for manipulating the at least one element of the mining equipment to accurately recover the material with mineral resources.

In another of its aspects, there is provided a computer-implemented method for improving the accuracy at least one element of a mining equipment manipulable to recover material with mineral resources, the method comprising the steps of:
acquiring at least one of geological data, survey data, and site location data corresponding to a geographical location having the material with mineral resources;
with a processor, executing a first set of instructions stored in the memory to cause the processor to generate at least one synthetic production polygon corresponding to a volume of interest with the mineral resources;
acquiring data corresponding to at least one of position and motion of the at least one element in a 3D space;
determining whether the at least one element of the mining equipment is properly positioned and/or oriented to recover the material with mineral resources; and
   when the at least one element of the mining equipment is not positioned and/or oriented properly, then causing the at least one element of the mining equipment to change location and orientation to suit the desired location and orientation for recovery of the material with mineral resources; else
   when the at least one element of a mining equipment is properly positioned and/or oriented then capturing real-time imagery associated with the geographical location and the at least one element of the mining equipment;
with the processor, executing a second set of instructions stored in the memory to cause the processor to combine the real-time imagery with the at least one synthetic production polygon and generate real-time composite imagery; and
presenting the real-time composite imagery on a display as a guide for manipulating the at least one element of the mining equipment to accurately recover the material with mineral resources.

In another of its aspects, there is provided a computer program product comprising at least one non-transitory computer-readable storage medium having instructions stored therein, the instructions executable by a processor to at least:
acquire at least one of geological data, survey data, and site location data corresponding to a geographical location having the material with mineral resources;
acquire data corresponding to at least one of position and motion of at least one articulating structure associated with an earth moving vehicle in a 3D space, said earth moving vehicle being located at the geographical location;
generate a virtual earth moving vehicle having the at least one virtual articulating structure in the 3D space;
generate at least one virtual production polygon corresponding to a volume of interest having mineral resources at the geographical location in the 3D space;
acquire captured image data of the geographical location;
combine the at least one virtual production polygon corresponding to a volume of interest having mineral resources at the geographical location and the captured image data of the geographical location to generate a first mixed-reality view for presentation on a first portion of a user interface;
combine the at least one virtual production polygon corresponding to a volume of interest having mineral resources at the geographical location, and the virtual earth moving vehicle having the at least one virtual articulating structure and the captured image data of the geographical location to generate a second mixed-reality view for presentation on a second portion of the user interface; and
based on the at least one of the first mixed-reality view displayed on the first portion of a user interface and the second mixed-reality view displayed on the second portion of the user interface, determine whether the at least one articulating structure is properly positioned and/or oriented to excavate the material with mineral resources based on the position data and motion location data of the at least one articulating structure, the site location data and the at least one virtual production polygon.

Advantageously, the precision mining platform reduces shovel operation errors by providing the operators with a better visual aid to dig the muck pile accurately according to the polygonal model guide. With each bucket load, the polygonal models are updated to reflect that some material has been recovered. The percentage of mineral ore and/or waste recovered in a given dig session is tracked in real-time, and equipment operator efficiency metrics are presented on a display for the equipment operator and the mining operator. In addition, the real-time dig accuracy and tracking leads to improved realized recovery of minerals, and improved overall equipment operator performance, and efficiency. Also, real-time tracking of the mining equipment assets, that is, mining shovel, haulage trucks, boom, and bucket, etc. in the precision mining platform allows for the streamlining of dispatch operations and communication with equipment operators. Furthermore, the precision mining platform minimizes human intervention and therefore reduces human error, such as misclassification of ore and waste, thereby improving the outcomes of the digging processes, including reduced costs, increased production, operational safety, and environmental sustainability.

### BRIEF DESCRIPTION OF THE DRAWINGS

Several exemplary embodiments of the present invention will now be described, by way of example only, with reference to the appended drawings in which:

FIG. 1 shows an exemplary mining platform;

FIG. 2 shows an exemplary environment in which an improved mining accuracy tool using augmented vision and mixed reality methods and systems operates;

FIG. 3 shows an exemplary user interface;

FIG. 4 shows another exemplary user interface; and

FIG. 5 shows a high level flow diagram illustrating exemplary process steps for operating mining equipment with improved accuracy based on real-time guidance and feedback from an augmented vision and mixed reality method and system.

### DETAILED DESCRIPTION OF EXEMPLARY EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

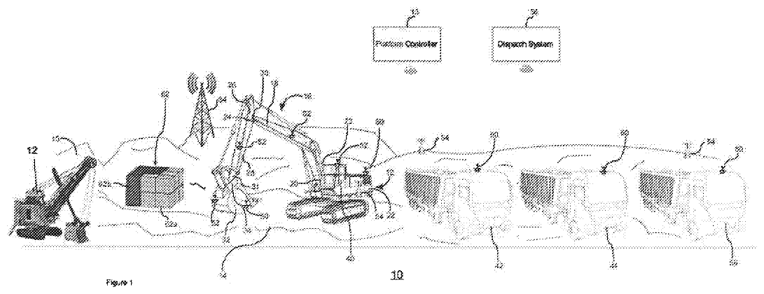

FIG. 1 shows a precision mining platform, generally identified by numeral 10, in an exemplary embodiment. Precision mining platform 10 improves the accuracy of mining equipment during an excavation event by tracking the precise location of mining equipment in a 3D spatial volume with predefined, marked regions associated with rock material having substantial mineral deposits; and by providing real-time feedback to cause precise placement of mining equipment to retrieve the rock material having substantial mineral deposits.

Precision mining platform 10 comprises exemplary mining equipment 12, such as a mining shovel and a rope shovel, and mining platform controller 13. Other mining equipment 12 may comprise excavators, backhoes, front-end loaders, electric mining shovels, and so forth. As an example, rope shovel 12 may have dipper payloads of 109 tonnes or more, and dipper capacities of 60 m3 or more, with boom lengths exceeding 20 m, such as the Cat®7495 Electric Rope Shovel, manufactured by Caterpillar Inc. of Peoria, Ill., U.S.A.

As can be seen in FIG. 1, mining shovel 12 is situated at an open-pit surface 14 of a mining site, and operable to dig and load earth or fragmented rock material 15 for mineral extraction. Mining shovel 12 comprises articulated arm 16 with boom 18 having proximal end 20 coupled to mining shovel body 22, and distal end 24 of boom 18 pivotably coupled to proximal end 26 of dipper arm 28 at pivot point 30. Distal end 31 of dipper arm 28 comprises bucket 32 pivotably connected thereto at pivot point 34. Articulated arm 16 and bucket 24 may be controlled by an electro-hydraulic system operated by an equipment operator located in cabin 40 of mining shovel 12 to move, manipulate, material 15 such as ore, waste and ore, dirt, or other waste, and load material 15 into designated haulage truck 42, 44 or 46. As an example, the payload capacity of haulage trucks 42, 44 and 46 may be 320 short tons, such as the Komatsu® 930E-4 haul truck manufactured by Komatsu Ltd., of Peoria, Ill., U.S.A. As an example, haulage truck 42 may be designated to receive material 15 identified to have significant quantities of mineral ore for recovery, haulage truck 44 may be designated to receive material 15 identified to have both appreciable quantities of mineral ore and some waste and therefore some ore may be recoverable; while haulage truck 46 may be designated to receive material 15 identified to have insignificant quantities of mineral ore, and therefore may such material be classified waste material.

Mining shovel 12 further comprises sensing devices associated with boom 18, dipper arm 28, bucket 32, and mining shovel body 22. For example, sensing devices may comprise location sensing devices 50 associated with any remote positioning system, whether terrestrial or non-terrestrial. For example, satellite based systems currently available include the global positioning system (GPS), and land-based systems can include Wi-Fi positioning systems, among others. Location sensing devices 50 track the position of mining shovel 12, including orientation thereof. Other sensing devices include motion sensing devices, such as inertial-movement unit sensors 52, which may be associated with articulated arm 16 and mining shovel 12, and responsive to the movement of articulated arm 16 and/or shovel 12, to permit orientation and positioning of mining shovel 12. Sensing devices 50, 52 may be communicatively coupled to relay transceiver 54, such as a base station or wireless access point to transmit the sensed signals via communication network 55 to mining platthrm controller 13, or receive control signals from mining platthrm controller 13. Haulage trucks 42, 44, 46 may include location sensing devices 50, as described above, and may be communicatively linked to mining shovel 12, mining platform controller 13 and dispatch system 56 via communication network 55.

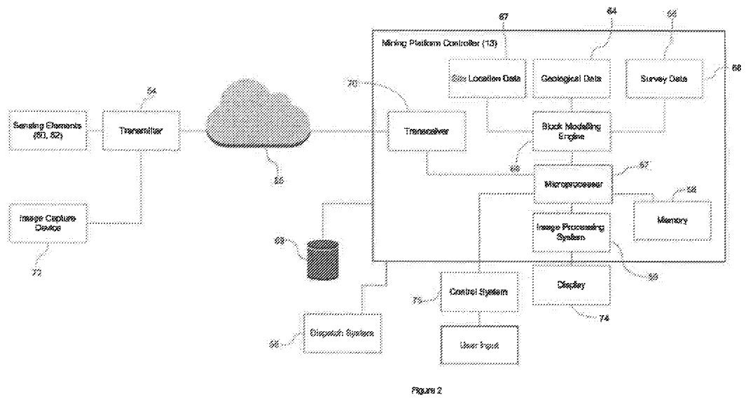

As shown in FIG. 2, mining platform controller 13 comprises processor 57, memory 58, image processing system 59, and block modelling engine 60. Geological data 64, survey data 66, and location data 67 pertaining to an area of interest or volume of interest having materials 15 with significant quantities of extractable ore is acquired and input into block modelling engine 60. Generally, block modelling engine 60 comprises a set of instructions stored in memory 58 associated with mining platform controller 13, with a plurality of lines of code executable by processor 57 to generate production polygons or synthetic graphical block models 62. Each production polygon 62 comprises a plurality of blocks 62a, 62b, and each block 62a or 62b comprises a block attribute which reflects the geological properties of block 62, such as density, rock type, reserves grade, etc. These predefined production polygons 62 are defined on open-pit surface 14, and guide equipment operators in excavating and loading rock material 15 into the correct stream, such as an ore stream, an ore/waste stream or a waste stream. Production polygons 62 are then stored in a memory 58 associated with mining platform controller 13, or stored in database 69.

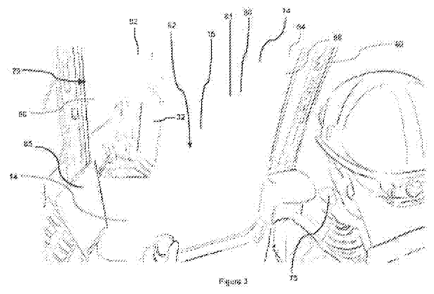

Processor 57 receives sensed data from the sensing devices, such as GPS sensors 50 and inertial-movement unit sensors 52, via transceiver 70, and image processing system 59 processes the real imagery of open-pit surface 14 captured by image capture device 72. Generally, image processing system 59 comprises a set of instructions stored in memory 58 associated with mining platform controller 13, with a plurality of lines of code executable by processor 57 to combine the real imagery with graphical block 62 locating the volume of interest, in conjunction with the sensed data, and for storage in memory 58 or database 69, and for access and retrieval in real-time. Accordingly, production polygon 62 is overlaid on imagery of open-pit surface 14 to create composite real-time image 79, and composite real-time image 79 is displayed on visual display screen 74, which may be a heads-up display (HUD), head-mounted display (HMD), hand held display unit, cabin windshield with display images from a projection unit, or any other graphical display. Image processing system 59 may thus comprise an augmented reality module, which mixes or juxtaposes synthetic block model elements 62 with real world elements, open-pit surface 14, in such a way that synthetic block model elements 62 appear to be part of open-pit surface 14. In FIG. 3, synthetic graphical block model wire frame outline 62 can be displayed on partially transparent/partially reflective cabin windshield 74, such that the operator sees real objects, such as bucket 32 and material 15 (acquired from image capture device 72) which appear to be mixed with synthetic block model element 62. Alternatively, video imagery of real objects can be combined with synthetic block 62 and the combination is displayed on a conventional video display monitor 74.

In more detail, looking again at FIG. 3, in addition to displaying block model wire frame outline 62 superimposed on real-time images of materials 15 at open-pit surface 14 on cabin windshield 74, other content may be displayed there too. For example, the content may include other information such as textual information 80, graphical information 82, widgets 84, and controls 86. Operator may interact with the content on cabin windshield 74 via controls 86, or via other input means, such as a pointing device, button, touch pad, touch-enabled display screen, microphone coupled to appropriate speech recognition system associated with mining platform controller 13. Alternatively, pointing device, button, touch pad, touch-enabled display screen, and microphone may be associated with operator computing device 85. For example, during the session, operator may enter the instruction “Show me the Session Stats” via any one of the input means. In response, image processing system 59 causes window 80 to be displayed on cabin windshield 74, with statistics 81 pertaining to the session, such as the percentage of ore recovered and the percentage of waste recovered. Another instruction might be: “Show me the block model” and in response, image processing system 59 causes synthetic block 62 to be displayed on cabin windshield 74.

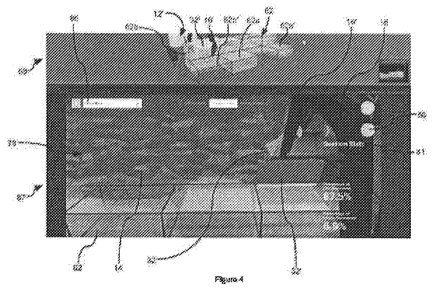

FIG. 4 shows another exemplary user interface presented on display 74 split into two portions 87, 88. Portion 87 comprises synthetic graphical block 62, synthetic articulated arm 16′ with synthetic bucket 32′, with block 62 being overlaid on real-time imagery of open-pit surface 14 to guide the equipment operator. Portion 88 comprises synthetic mining shovel 12′ having synthetic articulated arm 16′ with synthetic bucket 32′, and synthetic graphical block 62 in a 3D space representative of open-pit surface 14 in the field of view of image capture device 72. The interactive images in portion 88 show the remaining blocks 62a, 62b representative of the remaining material 15 to be excavated and loaded away by bucket 32, and blocks 62a′, 62b′ represent material 15 that has already been excavated and loaded away by bucket 32. Accordingly, after each bucket load, block 62 is updated in real-time to remove the portion 62a, or 62b, of block 62 representative of the material 15 that was loaded into bucket 32 for placement in one of the material streams, and portions 62a, 62b are replaced by portions 62a′, 62b′. Accordingly, the recovery rate and operator efficiency can be tracked. As an example, during any session the percentage of recovered mineral ore and waste may be tracked in real-time and session statistics 89 are displayed on display 74. In addition, blocks 62a, 62b may also be color-coded to represent the attributes of the mineral ore, such as grade or concentration, in each block 62a, 62b, and therefore aid in the classification of the excavated material 15 into the respective streams, such as, ore stream, ore/waste stream and waste stream. Any of the block attributes of blocks 62a, 62b may also be associated with shading and/or a transparent gradient.

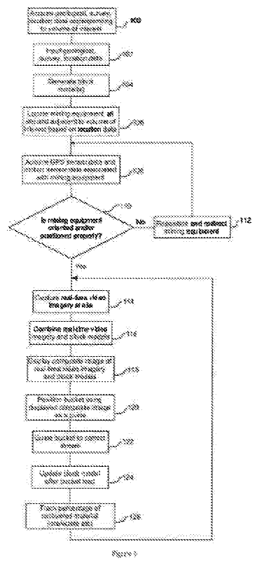

FIG. 5 shows a flow diagram outlining the exemplary steps for improving shovel accuracy. In step 100, geological data 64, survey data 66, and location data 67, pertaining to an area of interest or volume of interest having materials 15 at open-pit surface 14 with significant quantities of extractable ore, is acquired. Next, geological data 64, survey data 66, and location data 67 is input into mining platform controller 13 (step 102), and block modelling engine 60 generates production polygons 62 based on acquired data pertaining to the area of interest or volume of interest (step 104). Information pertaining to production polygons 62 is then stored in a memory associated with mining platform controller 13, or stored in database 69. Next, mining shovel 12 is positioned at open-pit surface 14, adjacent to volume of interest, based on location data 67 (step 106), and sensor data associated with mining shovel 12 is acquired (step 108). Generally, mining shovel sensor data comprises GPS location coordinates from GPS sensors 50 and motion data from inertial-movement unit sensors 52 associated with articulated arm 16 and/or cabin 40. In step 110, a determination is made by mining platform controller 13 as to whether mining shovel 12 is properly positioned and or oriented to excavate materials 15 of the volume of interest, and deposit excavated materials 15 into haulage trucks 42, 44, 46. When mining shovel 12 is not properly positioned and/or oriented, then mining shovel 12 is caused to change location and orientation to suit the desired location and direction (step 112), and the process returns to step 108. Otherwise, when mining shovel 12 is properly positioned and/or oriented, then image capture device 72 captures real-time video imagery of real objects in its field of vision, such as material 15, open-pit surface 14, bucket 36, and other objects such as haulage trucks 42, 44, 46, or other mining equipment (step 114).

In step 116, imaging processing system 59 combines real-time video imagery from step 114 with synthetic block models 62 generated in step 104, and real-time composite image 79 is displayed on display 74 (step 118), such as cabin windshield or a video display monitor. As noted above, synthetic block models 62 represent the volume of interest, and depending on the geological nature of the volume of interest, synthetic block model elements 62 may include blocks 62a, 62b indicative of the presence of mineral ore deposit, or varying concentrations thereof within a single block model element 62. Accordingly, an equipment operator can be visually guided to precisely position bucket 32 using the displayed composite image 79 (step 120). Having the knowledge of the attributes of block model elements 62a, 62b enables an equipment operator to systematically orient and position bucket 32 via control system 75, and excavate the desired material 15 of the volume of interest, and place the excavated material 15 in the correct stream, that is, ore stream, ore/waste stream and waste stream (step 122). Control system 75 may comprise a set of instructions stored in memory 58, with a plurality of lines of code executable by processor 57 to position bucket 32 automatically. After each bucket 32 load, block 62 is updated to remove portion 62a or 62b of block 62 representative of the material 15 that was loaded into bucket 32 for placement in one of the material streams (step 124), and portion 62a or 62b is replaced by portion 62a′ or 62b′, respectively, to represent an empty block or removed material 15. Accordingly, during the session block 62 is deformed with each bucket 32 load and the percentage of recovered mineral ore and waste is tracked in real-time (step 126), which may be recorded and displayed on display 74.

In addition, haulage trucks 42, 44, 46 comprise location sensing devices 50, such as GPS sensors or Wi-Fi position sensors for tracking movement thereof, and for allowing operators of haulage trucks 42, 44, 46 to receive directions and allow proper parking of haulage trucks 42, 44, 46 to receive excavated material 15 from mining shovel 12.

Mining platform controller 13 may further comprise other components, such as a storage device, video processor, and I/O controller for coupling a number of input/output (I/O) devices thereto, such as a keyboard, touch screen, pointing device, and a communications interface device. The components of mining platform controller 13 may be coupled by an interconnection mechanism, which may include one or more buses (e.g., between components that are integrated within a same machine) and/or a network (e.g., between components that reside on separate discrete machines).

In another implementation, communication between mining equipment assets 12, 42, 44, 46, equipment operators, dispatch center or dispatch system 56, within precision mining platform 10 allows for the streamlining of dispatch operations and management of all assets 12, 42, 44, 46, and personnel.

In another implementation, precision mining platform 10 may control mining shovel 12 to accurately load excavated materials into waiting haulage trucks 42, 44, 46, based on the classification of the material. Therefore, haulage trucks 42, 44, 46 may be represented as a synthetic element in the composite video, while bucket 32, materials 15 and open-pit surface 14 represent real-time video imagery.

In another implementation, sensing devices are communicatively linked to mining platform controller 13 via a wired or wireless connection controller; or communicatively linked to platform transmitter 54 via a wired or wireless connection.

In another implementation, sensing devices may include load sensors, proximity sensors, pressure sensors, temperature, flow, mass, heat sensors, humidity sensors, position sensors, velocity sensors, accelerometers, vibration sensors, gyroscope sensors, among others.

In another implementation, display 74 is wirelessly linked to image processor system 59.

In another implementation, precision mining platform 10 may guide an operator in performing an excavation remotely.

In another implementation, mining shovel 12 autonomously or semi-autonomously positions itself on open-pit surface 14 based on location data, and orients and positions bucket 32 during an excavation event, a loading event, and a classification event of material 15 into one or more streams.

In another implementation, precision mining platform 10 automates surveying of the geographical area, post-blast inspection, shovelling of material 15 and hauling of material 15, sorting of material 15 into a stream (ore stream/ore-waste stream and waste stream) and real-time assay of material 15.

In another implementation, haulage trucks 42, 44, 46 may be a rail car, flexible conveyor train, in-pit crushing hopper, and/or truck with an open bed trailer, etc.

In another implementation, database 69 may be any type of data repository or combination of data repositories, which store records or other representations of data comprising any data associated with mining platform 10, such as open-pit profile data, geological data, survey data, sensed data, positioning data, operational data, production data, equipment operator profile data, mining operator data, and statistical data.

In another implementation, as shown in FIG. 3, synthetic graphical block model wire frame outline 62 can be displayed on cabin windshield 74, such the operator sees real objects, such as bucket 32 and material 15 (through cabin windshield 74) which appear to be mixed with block 62 (projected onto cabin windshield 74 by reflection a projection unit). Alternatively, video imagery of real objects can be combined with computer generated graphics 26′ and/or production polygons 62, and markers detectable by image processing system 59 from the real-time imagery acquired by image capture device 72 may be employed, such that a combined real-time interactive image is presented on display 74 using augmented reality and mixed reality techniques.

In another implementation, one or more of the components and/or one or more additional components of the example environment of FIG. 2 may each include memory for storage of data and software applications, a processor for accessing data and executing applications, and components that facilitate communication over a network. In some implementations, the components may include hardware that shares one or more characteristics with the example computer system that is illustrated in FIG. 1.

In another implementation, mining platform controller 13 may comprise a server which executes a web server application, examples of which may include but are not limited to: Microsoft IIS or Apache® Webserver, that allows for HTTP (i.e., HyperText Transfer Protocol) access to server computer 70 via communication network 55.

In another implementation, operator computing device 85 include any device, such as, a personal computer, laptop, tablet, computer server, or smartphone.

The logic of FIG. 5 can be implemented in software and/or hardware, and when implemented as software, the software is stored in memory and executed by a microprocessor. The logic (as well as the other software and software logic described in this document), which comprises an ordered listing of executable instructions for implementing logical functions, can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable medium” can be any means that can contain or store the program for use by or in connection with the instruction execution system, apparatus, or device. The non-transitory computer readable medium can be, for example but not limited to, an electronic, magnetic, optical, electromagnetic, infrared, or semiconductor system, apparatus, or device. More specific examples (a non-exhaustive list) of the non-transitory computer-readable medium would include the following: a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CD-ROM) or DVD (optical). The software and software logic described above comprises an ordered listing of executable instructions for implementing logical functions, can be embodied in any non-transitory computer-readable medium for use by or in connection with an instruction execution system, apparatus, or device, such as a computer-based system, processor-containing system, or other system that can fetch the instructions from the instruction execution system, apparatus, or device and execute the instructions.

In other implementations, various aspects of the invention may be distributed among one or more computer systems (e.g., servers) configured to provide a service to one or more client computers, or to perform an overall task as part of a distributed system. For example, various aspects of the invention may be performed on a client-server, hybrid client-server, or multi-tier system that includes components distributed among one or more server systems that perform various functions according to various embodiments of the invention.

In other implementations, processor 57 may be configured to execute hard-coded functionality.

In one embodiment, processor 57 may be embodied as a multi-core processor, a single core processor, or a combination of one or more multi-core processors and one or more single core processors. For example, processor 57 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, Application-Specific Standard Products (ASSPs), System-on-a-chip systems (SOCs), Complex Programmable Logic Devices (CPLDs), Graphics Processing Units (GPUs), and the like. For example, some or all of the device functionality or method sequences may be performed by one or more hardware logic components.

Communications network 55 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network. Communication network 55 may be connected to one or more secondary networks, examples of which may include but are not limited to: a local area network; a wide area network; or an intranet, for example.

Database 69 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention. Alternatively, database 69 is communicatively coupled to mining platform controller 13.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a nonexclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1. A precision mining system having mining equipment manipulable to recover material with mineral resources, the system comprising:
an image sensor for capturing real-time imagery of a geographical location having material with mineral resources and at least one element of the mining equipment;
a display device;
a storage device comprising instructions and the real-time imagery; and
a processor configured to execute the instructions to receive, from the image sensor, real-time imagery;
at least one sensing device associated with at least one element of the mining equipment configured to acquire data corresponding to at least one of position and motion of the at least one element of the mining equipment in the real-time imagery;
the processor configured to execute the instructions to generate at least one production polygon corresponding to a volume of interest with the mineral resources;
an image processing system adapted to receive the real-time imagery and the at least one production polygon, the image processing system comprising a second set of instructions stored in the storage device and the instructions executable by the processor to cause the processor to combine the real-time imagery with the at least one production polygon to generate real-time composite imagery; and
a display unit for presenting the real-time composite imagery as a guide for manipulating the at least one element of the mining equipment to accurately recover the material with mineral resources.

2. The precision mining system of claim 1, wherein the at least one production polygon is generated using at least one of geological data, survey data, and site location data corresponding to a geographical location having the material with mineral resources.

3. The precision mining system of claim 2, wherein the processor is configured to receive, from a modelling engine, the at least one production polygon corresponding to a volume of interest with the mineral resources.

4. The precision mining system of claim 3, wherein the at least one sensing devices provides at least one of positional data and velocity data of the at least one element of the mining equipment a 3D space.

5. The precision mining system of claim 4, wherein at least one of positional data and velocity data is received and analyzed by the processor to track the movement of the at least one element of the mining equipment in real time, wherein the at least one element of the mining equipment is one of a boom, a dipper arm and an excavation bucket.

6. The precision mining system of claim 5, wherein the processor provides navigational data instructive for placement of the mining equipment for excavation of the material in an excavation event, and subsequent loading of the materials into a haulage truck positioned in a predetermined location based on the least one of positional data and velocity data.

7. The precision mining system of claim 6, wherein the processor receives and processes the at least one of positional data and velocity data to permit orientating and positioning of the excavation bucket during at least one of an excavation event, loading event and classification event.

8. The precision mining system of claim 7, wherein the at least one production polygon comprises a plurality of blocks, and each block comprises at least one block attribute which reflects athe geological body's properties of the at least one production polygon.

9. The precision mining system of claim 8, wherein the at least one block attribute comprises at least one of density, rock type, and reserves grade.

10. The precision mining system of claim 9, wherein the at least one block attribute is employed to classify a rock material as at least one of ore material, ore/waste material and waste material.

11. The precision mining system of claim 10, wherein the at least one block attribute is associated with at least one of a color, shading and transparent gradient.

12. The precision mining system of claim 11, wherein the at least one production polygon is updated following each excavation event to show unexcavated material.

13. The precision mining system of claim 12, wherein the display unit comprises a graphical portion comprising statistics pertaining to the excavation event.

14. The precision mining system of claim 13, wherein the statistics comprise at least one of a percentage of ore recovered and a percentage of waste recovered.

15. The precision mining system of claim 14, wherein a control system receives at least one block attribute, positional data, excavation data, and generates instructions to position and orient the bucket to excavate a desired material of the volume of interest, and place an excavated material in at least one of an ore stream, an ore/waste stream and a waste stream, thereby minimizing misclassification of the ore material, ore waste material and the waste material.

16. The precision mining system of claim 15, wherein the control system autonomously or semi-autonomously positions and orients the excavation bucket during at least one of an excavation event, a loading event, and a classification event of the material in the at least one of an ore stream, an ore/waste stream and a waste stream.

17. The precision mining system of claim 7, wherein positional data associated with the mining equipment and the haulage truck is used to streamline dispatch operations.

18. A computer-implemented method for improving the accuracy of at least one element of a mining equipment manipulable to recover material with mineral resources, the method comprising the steps of:
acquiring at least one a of geological data, a survey data, and a site location data corresponding to a geographical location having a material with mineral resources;
with a processor, executing a first set of instructions stored in a memory to cause the processor to generate at least one synthetic production polygon corresponding to a volume of interest with the mineral resources;
acquiring data corresponding to at least one of position and motion of the at least one element of the mining equipment in a 3D space;
determining whether the at least one element of the mining equipment is properly positioned and/or oriented to recover the material with mineral resources; and
when the at least one element of the mining equipment is not positioned and/or oriented properly, then causing the at least one element of the mining equipment to change location and orientation to suit a desired location and orientation for recovery of the material with mineral resources; else
when the at least one element of a mining equipment is properly positioned and/or oriented then capturing a real-time imagery associated with the geographical location and the at least one element of the mining equipment;
with the processor, executing a second set of instructions stored in the memory to cause the processor to combine the real-time imagery with the at least one synthetic production polygon and generate a real-time composite imagery; and
presenting the real-time composite imagery on a display as a guide for manipulating the at least one element of the mining equipment to accurately recover the material with mineral resources.

19. The method of claim 18, wherein the at least one synthetic production polygon comprises a plurality of blocks, and each block comprises an at least one block attribute reflecting the geological body's properties of the at least one synthetic production polygon.

20. The method of claim 19, wherein the at least one block attribute comprises at least one of density, rock type, and reserves grade.

21. The method of claim 20, wherein the at least one block attribute is associated with at least one of a color, shading and transparent gradient.

22. The method of claim 21, wherein the at least one synthetic production polygon comprises a wire frame outline.

23. The method of claim 22, wherein with the processor, executing a third set of instructions stored in the memory to cause the processor to present the at least one synthetic production polygon comprising the wire frame outline on a display means.

24. The method of claim 23, wherein the display means is at least one of a windshield of the mining equipment, a display screen, a heads-up display (HUD), and a head-mounted display (HMD).

25. The method of claim 20, wherein a control system receives the at least one block attribute, the geological data, the survey data, the site location data, and a positional data, and generates instructions to position and orient the at least one element of the mining equipment to excavate or recover the material with mineral resources, and place an excavated material in at least one of an ore stream, an ore/waste stream and a waste stream.

26. The method of claim 18, wherein a control system autonomously or semi-autonomously positions and orients the at least one element of the mining equipment during an excavation event, a loading event, and a classification event of the material in at least one of an ore stream, an ore/waste stream and a waste stream.

27. A computer program product comprising at least one non-transitory computer-readable storage medium having instructions stored therein, the instructions executable by a processor to at least:
acquire at least one of a geological data, a survey data, and a site location data corresponding to a geographical location having a material with mineral resources;
acquire data corresponding to at least one of a position and a motion of an at least one virtual articulating structure associated with an earth moving vehicle in a 3D space, said earth moving vehicle being located at the geographical location;
generate a virtual earth moving vehicle having the at least one virtual articulating structure in the 3D space;
generate an at least one virtual production polygon corresponding to a volume of interest having mineral resources at the geographical location in the 3D space;
acquire a captured image data of the geographical location;
combine the at least one virtual production polygon corresponding to a volume of interest having mineral resources at the geographical location and the captured image data of the geographical location to generate a first mixed-reality view for presentation on a first portion of a user interface;
combine the at least one virtual production polygon corresponding to a volume of interest having mineral resources at the geographical location, and the virtual earth moving vehicle having the at least one virtual articulating structure and the captured image data of the geographical location to generate a second mixed-reality view for presentation on a second portion of the user interface; and
based on the at least one of the first mixed-reality view displayed on the first portion of a user interface and the second mixed-reality view displayed on the second portion of the user interface, determine whether the at least one virtual articulating structure is properly positioned and/or oriented to excavate the material with mineral resources based on the position data and motion location data of the at least one virtual articulating structure, the site location data and the at least one virtual production polygon.

28. The computer program product of claim 27, comprising instructions executable to receive commands to cause an excavation session information to be displayed on at least one of the first portion of the user interface, the second portion of the user interface, and a third portion of the user interface.

29. The computer program product of claim 28, wherein the excavation session information comprises statistics pertaining to an excavation session.

30. The computer program product of claim 29, wherein the least one virtual articulating structure is one of a boom, a dipper arm and an excavation bucket.
